(19) United States
(12) Patent Application Publication
(10) Pub. No.: US 2022/0397940 A1
(43) Pub. Date: Dec. 15, 2022

(54) LATCH MECHANISM

(71) Applicant: Hewlett-Packard Development Company, L.P., Spring, TX (US)

(72) Inventors: Chung-Hua Ku, Taipei City (TW); Kuo-Chih Huang, Taipei City (TW); Hung-Sung Pan, Taipei City (TW)

(73) Assignee: Hewlett-Packard Development Company, L.P., Spring, TX (US)

(21) Appl. No.: 17/635,712

(22) PCT Filed: Nov. 19, 2019
(86) PCT No.: PCT/US2019/062121

§ 371 Date: Feb. 16, 2022

(51) Int. Cl. G06F 1/16; E05C 1/12

(52) U.S. Cl. CPC G06F 1/1679; E05C 1/12

(57) ABSTRACT

An apparatus can comprise a cover coupleable to a computing device and a latch mechanism. An example latch mechanism is actuatable via insertion of a portion of a shaft through an aperture of the latch mechanism to cause the cover to be disengaged from the computing device.

### BACKGROUND

Electronic devices (e.g., computing devices) can include a cover to protect components interior to the device, such as a motherboard or other interior component(s), as well as exterior components, such as a keyboard. The cover of a computing device can be affixed semi-permanently or permanently to the computing device.

### BRIEF DESCRIPTION OF THE DRAWINGS

FIG. 1 illustrates an example of an apparatus with a latch mechanism consistent with the disclosure.

FIG. 2A illustrates an example of an apparatus with a latch mechanism and a shaft consistent with the disclosure.

FIG. 2B illustrates an example of an apparatus with a latch mechanism and a shaft consistent with the disclosure.

FIG. 3 illustrates an example apparatus consistent with the disclosure.

FIG. 4 illustrates an example of an apparatus consistent with the disclosure.

### DETAILED DESCRIPTION

Computing devices can include a cover that can be assembled from multiple cover portions to protect the internal components of the computing device from exposure to external forces. In this manner, a computing device cover can include cover portions that can be coupleable to one another and/or to a computing device. Fasteners (e.g., screws) can be used to affix the cover portions together and/or to the computing device. External tools (e.g., screwdrivers) can be used to separate the cover portions to remove the cover from the computing device. In some approaches, constituent portions of the covers can be separated by removing the screws to disengage the cover portions from one another and/or from the computing device, and subsequently moving the cover and/or the portions of the cover outward and away from each other. However, using fasteners to affix the covers, as well as external tools to separate the covers away from each other, can be time consuming and expensive. For simplicity, the terms “cover” and “portions of a cover,” as well as derivatives thereof may be used interchangeably herein.

In contrast, in some examples, a cover and/or portions of a cover that can be coupled to a computing device can be affixed (e.g., coupled to) and/or disengaged (e.g., de-coupled) from one another and/or the computing device using a latch mechanism, as described herein. As used herein, the term “coupleable” refers to a condition in which a first member (e.g., a device, a component, a piece of material, etc.) can be removably attached to, or removably detached from, a second member. The latch mechanism can be engaged with the cover and/or constituent portions of the cover or can be disengaged from the cover. The latch mechanism can be attached to the cover during manufacturing, or can be attached to the cover post-manufacturing.

In some examples, the latch mechanism can be actuated by inserting a portion of a shaft into an aperture disposed in the cover. As used herein, the term “shaft” refers to an extruded material that is characterized by a cross-sectional profile that extends a greater length in at least one spatial dimension than a length that it extends in a second spatial dimension. In some examples, a shaft can be formed from a material or combination of materials that provide an amount of rigidity that allows for the shaft to be inserted into the aperture to cause actuation of the components described herein. Non-limiting examples of shafts can include pins, keys, needles, or other extruded materials that are suitable for insertion into an aperture. In some examples, a portion of the shaft can be received through the aperture. For example, the aperture can receive a portion of a key and/or a pin. In some examples, the shaft can be removed from the aperture to affix the cover to the computing device.

The latch mechanism can allow the cover to be affixed and/or be disengaged from the computing device. In some examples, the cover of the apparatus can include adjustable posts that can unlock when the latch mechanism is actuated. Unlocking the posts can cause the cover to move from a first position to a second position (e.g. sliding the cover away from the base of the computing device). Such latch mechanism can help reduce cost as well as save time. Additionally, the ease of affixing and disengaging the cover with such latch mechanism can make it easy to replace and/or upgrade internal components of the computing device post manufacturing.

In some approaches, an access panel of an apparatus (e.g. a computing device) may be configured to be tool-lessly releasable to expose a portion of a housing for an apparatus. As described herein, the term “tool-less” refers to performing an action to remove a cover of a computing device without using an external tool. However, approaches that rely on tool-less releasable covers do not affix and/or remove the cover from the base by sliding a portion of the cover across the base.

In some approaches, a cover of an apparatus may include multiple “squeezable” portions that, when actuated together, allow for two portions of the cover to be separated. However, such mechanism does not include a latch mechanism coupleable to the cover to remove the cover easily across the base of an apparatus to replace and/or upgrade internal components post manufacturing.

In some approaches, a computing device can include a small opening in the side of an enclosure that covers a connection port that engages a shaft to actuate a door. However, such mechanism does not include a cost effective, easily removable latch mechanism having a rotor that is coupled to adjustable posts that unlock when the latch mechanism is actuated via a portion of a shaft. As used herein, the term “rotor” refers to a rotatable object that can rotate around a fixed point or about a fixed axis. As is further described in more detail herein, a rotor can refer to a portion of the latch mechanism that revolves in response to receiving force from the shaft.

Accordingly, the disclosure is directed towards a latch mechanism to disengage a cover coupleable to a computing device. The latch mechanism, when actuated by insertion of a portion of a shaft into an aperture disposed in the cover (e.g., a “D-cover”) of a computing device, can cause the cover to be disengaged and/or removed from the computing device.

The cover can be coupleable to a computing device. An aperture can be disposed in the cover (e.g., formed through the cover) to receive a portion of a shaft. In some examples, the cover can include an adjustable post. In some examples, a latch mechanism can be coupled to the cover, as further described herein. The cover can move from a first position to a second position relative to the computing device.

The latch mechanism can include a slideable member, a rotor and an aperture to receive a portion of a shaft to disengage the cover from a computing device. The insertion of the portion of shaft can cause the rotor of the latch mechanism to be actuated, as further described herein. In some examples, the rotor can actuate the latch mechanism to cause the cover to move from a first position to a second position relative to the computing device. For example, when the computing device is positioned on a horizontal plane, the cover can move from a first position to a second position along the horizontal plane. In other words, the cover can slide, horizontally, from the base of the computing device to be disengaged from the computing device.

The latch mechanism can include a slideable member. As used herein, the term “member” refers to a constituent piece of a structure, such as the latch mechanism described herein. The member can be formed from a rigid or semi-rigid material such as plastic, metal, and/or other material. The slideable member can be attached to the rotor. In some examples, the slideable member can be actuated in response the rotor being actuated. The slideable member can include a first slideable portion. In some examples, the first slideable portion can house a portion of the rotor. The slideable member can include a second slideable portion. In some examples, the second slideable portion can move from a first position to a second position in response to the shaft being received the rotor, as further described herein.

In some examples, the slideable member can include a biased slideable portion. As used herein the term “biased slideable portion” refers to a constituent piece of the slideable member that includes a coil spring to maintain a force between contacting surfaces. In some examples, the coil spring can be coiled around a metal, plastic and or other portion of the slideable member. In some examples, the biased slideable member can be parallel the first slideable portion of the slideable member. In some examples, the biased slideable portion can compress to shift the second slideable portion from a first position to a second position and cause an adjustable post to be unlocked.

The biased slideable portion can be coupled to the rotor. In some examples, the biased slideable portion can be operable to adjust the slideable member based on the actuation of the rotor. For example, when the rotor is actuated the biased slideable portion can be decompressed and the slideable member can move from a first position to second position. In response to the slideable member moving from a first position to second position, the rotor can be actuated. When the slideable member moves from a first position to a second position, an adjustable post, coupled to the latch mechanism can be unlocked.

The latch mechanism can include a rotor. The rotor can have a central axis about which it rotates. The rotor can be in contact with a slideable member. The rotor can include a first rotor portion. In some examples, the first rotor portion can be actuated in response to receiving a portion of a shaft via an aperture. In some examples, actuation of the rotor can actuate the latch mechanism. Actuation of the latch mechanism can cause the cover to be disengaged from the computing device, as further described herein.

The latch mechanism can include an aperture or a portion of the aperture via which a portion of a shaft can be received. In some examples, another portion of the aperture can be disposed in the cover. The aperture can receive a shaft. In some examples, the shaft can actuate the rotor by engaging a portion of the shaft with a portion of the rotor when the shaft is inserted through the aperture. In response to actuating the rotor, the slidable member can be actuated and the adjustable posts coupled to the latch mechanism can be disengaged to allow the cover to be disengaged from the computing device.

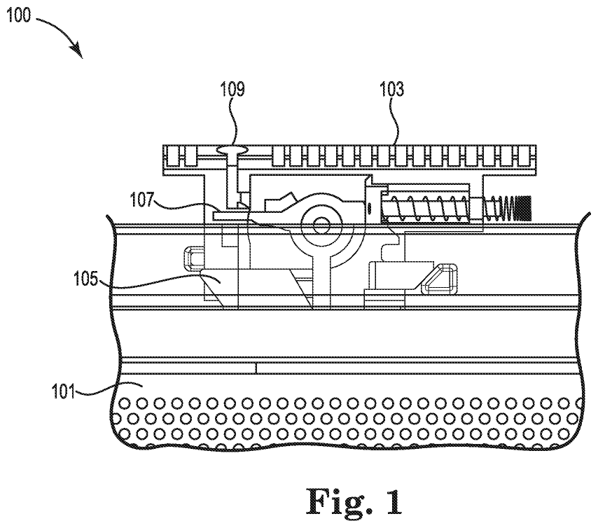

FIG. 1 illustrates an example of an apparatus 100 with a latch mechanism 103 consistent with the disclosure. The apparatus 100 can include a cover 101, which can be coupleable to a computing device (not shown in FIG. 1). The apparatus 100 can include a slideable member 105, a rotor 107, and an aperture 109.

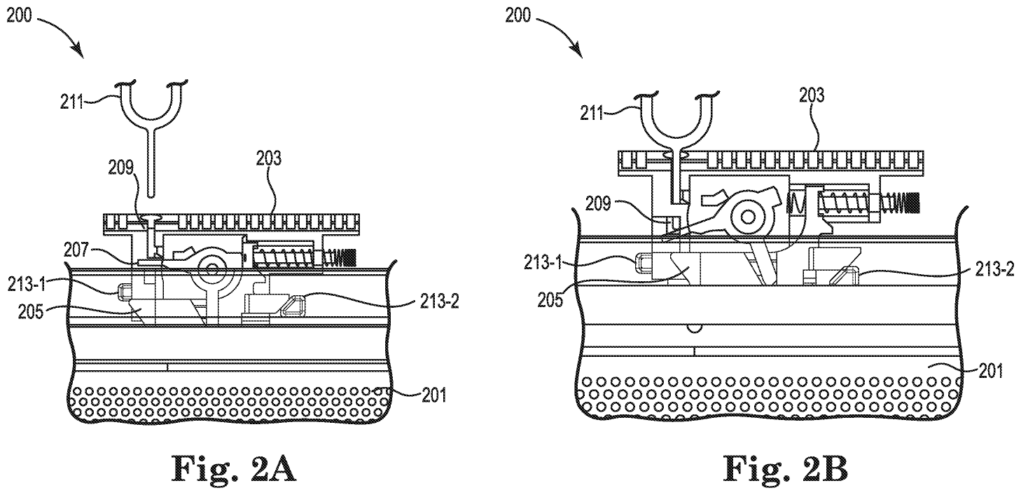

The apparatus 100 can include a cover 101 coupleable to a computing device. In some examples, the aperture 109 can be disposed (e.g., can be formed such that the aperture extends through the cover) in the cover 101 to receive a portion of a shaft (as shown in FIGS. 2A and 2B). The portion of the shaft can comprise a portion of a key and/or a portion of a pin.

In some examples, the apparatus 100 can include an adjustable post (not shown in FIG. 1). In some examples, a latch mechanism 103 can be coupled to the cover 101. The cover 101 can move from a first position to a second position along relative to the computing device. For example, the cover 101 can slide across the base of the computing device from a first position (e.g. affixed with the base of the computing device) to a second position (e.g., removed from the base of the computing device).

The apparatus 100 can include a latch mechanism 103. The latch mechanism can include a slideable member 105, a rotor 107, and an aperture 109 to receive a portion of a shaft to disengage the cover from a computing device. The latch mechanism 103 is actuatable via insertion of a portion of a shaft through an aperture 109 of the latch mechanism 103 to cause the cover 101 to be disengaged from the computing device. For example, the rotor 107 can receive a shaft via the aperture 109. In response to receiving the shaft, the rotor 107 can actuate the latch mechanism 103. Actuation of the latch mechanism 103 can cause the cover 101 to move from a first position to a second position along a relative to the computing device. As such cover 101 can slide, horizontally, from the base of the computing device to be disengaged from the computing device. The latch mechanism 103 can include a slideable member 105. The slideable member 105 can be coupled to the rotor 107. In some examples, the slideable member 105 can be actuated in response the rotor 107 being actuated. In some examples, a portion of the slideable member 105 extends a first distance along a first surface of the latch mechanism 103. For example, the slideable member 105 can extend a first distance along a first surface of the latch mechanism 103 when the first surface of the latch mechanism 103 is parallel to a surface of a base of the computing device.

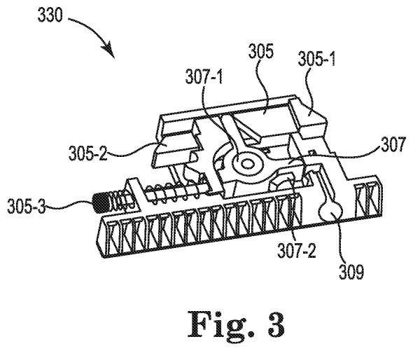

The slideable member 105 can include a first slideable portion (as shown in FIG. 3). In some examples, the first slideable portion can house a portion of the rotor 107. In some examples, the slideable member 105 can include a second slideable portion (as shown in FIG. 3). In some examples, the second slideable portion can move from a first position to a second position in response to the shaft being received the rotor 107. In some examples, the slideable member 105 can include a biased slideable portion (as shown in FIG. 3). In some examples, the biased slideable portion can compress to shift the second slideable portion and cause an adjustable post to be unlocked. In some examples, a biased slideable portion of the slideable member 105 is operable based on the actuation of the rotor 107. The slideable member 105 can be operable based on the actuation of the rotor 107. For example, when the rotor 107 is actuated the biased slideable portion can be decompressed and the slideable member 105 can move from a first position to second position. In response to the slideable member 105 moving from a first position to second position, the rotor 107 can be actuated. When the slideable member 105 moves from a first position to a second position, an adjustable post, coupled to the latch mechanism can be unlocked.

The latch mechanism 103 can include a rotor 107. The rotor 107 can be in contact with a slideable member 105. The rotor 107 can include a first rotor portion (as shown in FIG. 3). In some examples, the first portion can be actuated in response to receiving a portion of a shaft via the aperture 109. In some examples, actuation of the rotor 107 can actuate the latch mechanism 103. Actuation of the latch mechanism 103 can cause the cover 101 to be disengaged from the computing device.

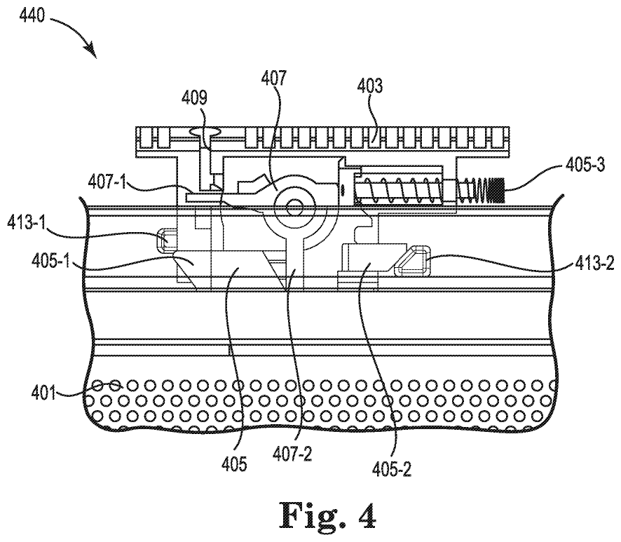

The latch mechanism 103 can include an aperture 109. The aperture 109 can be proximal to the rotor 107. In some examples, the actuation of the rotor 107 causes an adjustable post to unlock. For examples, the aperture 109 can receive a shaft via which the rotor 107 can be actuated. In response to the rotor 107 being actuated an adjustable post (e.g., 413-1 as shown in FIG. 4) can be unlocked. Unlocking the adjustable post can cause the cover to be disengaged from the computing device.

In some examples, the aperture 109 is to receive the portion of the shaft to actuate the rotor 107. In some examples, the aperture 109 can actuate the rotor 107 by engaging a portion of the shaft with the rotor 107. In response to actuating the rotor 107, the latch mechanism 103 can actuate the slideable member 105 and disengage the adjustable posts coupled to the latch mechanism 103.

The latch mechanism 103 can include a rotor 107. The rotor 107 can be in contact with the slideable member 105. The rotor 107 can include a first rotor portion (as shown in FIG. 3). In some examples, the first portion can be actuated in response to receiving a portion of a shaft via the aperture 109.

In some examples, 109 is to receive the portion of the shaft to actuate the rotor 107. In some examples, actuation of the rotor 107 actuates the latch mechanism 103 to cause the cover 101 to move from a first position to a second position relative the computing device. In some examples, actuation of the rotor 107 can actuate the latch mechanism 103. Actuation of the latch mechanism 103 can cause the cover 101 to be disengaged from the computing device.

The latch mechanism 103 can allow the cover 101 to be affixed and/or be disengaged from the computing device. In some examples, the cover 101 of the apparatus 100 can include adjustable posts that can unlock when the latch mechanism 103 is actuated. Unlocking the posts can cause the cover 101 to move from a first position to a second position (e.g. sliding the cover away from the base of the computing device). Sliding the cover 101 to unlock the adjustable posts, via actuatable latch mechanism, can help avoid using expensive fasteners and/or multiple fasteners to secure the cover to the base. As such, latch mechanism can help reduce cost as well as save time. The ease of disengaging the cover with the latch mechanism provides the flexibility to replace and/or upgrade internal components.

FIG. 2A illustrates an example of an apparatus 200 with a latch mechanism 203 consistent with the disclosure. The apparatus 200, as shown in FIG. 2A, is an example of latch mechanism 203 without a shaft 211 being received by the latch mechanism 203. The apparatus 200 can include a cover 201, which can be coupleable to a computing device (not shown in FIG. 2). The apparatus 200-can include a slideable member 205, a rotor 207, an aperture 209, and adjustable posts 213-1 and 213-2.

The shaft 211 can be an external device. In some examples, the shaft 211 is not received by the aperture 209 of the latch mechanism 203. When the shaft 211 is not received by the latch mechanism 203, the adjustable posts 213-1 and 213-2 are in a locked position. In response to the adjustable posts 213-1 and 213-2 being in the locked position, the cover 201 can be affixed to a base of a computing device.

FIG. 2B illustrates an example of an apparatus 200 with a latch mechanism 203 consistent with the disclosure. The apparatus 200, as shown in FIG. 2B, is an example of a latch mechanism 203 with a shaft 211 being received by the latch mechanism 203 via the aperture 209.

In response to receiving the shaft 211 via the aperture 209, the rotor 207 can come in contact with the shaft 211 and push a portion of the rotor 207 towards the cover 201. In response to that, a biased portion of the slideable member 205 compresses, and the slideable member 205 moves from a first position to a second position. When the slideable member 205 moves from the first position to the second position, the adjustable post 213 is unlocked.

FIG. 3 illustrates an example apparatus 330 consistent with the disclosure. The apparatus 330 can be analogous to a latch mechanism 103 as described in relation to FIG. 1. The apparatus 330 can include a slideable member 305, a rotor 307, and an aperture 309 to receive a portion of a shaft to disengage the cover from a computing device. The apparatus 330 is actuatable via insertion of a portion of a shaft through an aperture 309 disposed in a of cover of a computing device analogous to cover 101 described in relation to FIG. 1.

The apparatus 330 can include a slideable member 305. The slideable member 305 can be coupled to the rotor 307. In some examples, the slideable member 305 can be actuated in response to the rotor 307 being actuated. In some examples, a portion of the slideable member 303 extends a first distance along a first surface of the apparatus 330.

The slideable member 305 can include a first slideable portion 305-1. In some examples, the first slideable portion 305-1 can house a portion of the rotor 307. For example, a first rotor portion 307-1 of the rotor 307 can be housed by the first slideable portion 305-1.

In some examples, the slideable member 305 can include a second slideable portion 305-2. In some examples, the second slideable portion 305-2 can move from a first position to a second position in response to a shaft (e.g., the shaft 211 described in relation to FIGS. 2A and 2B) coming into contact with the rotor 307.

In some examples, the slideable member 305 can include a biased slideable portion 305-3. In some examples, the biased slideable portion 305-3 can compress to shift the second slideable portion 305-2 and cause an adjustable post to be unlocked. In some examples, a biased slideable portion 305-3 of the slideable member 305 is operable based on the actuation of the rotor 307. The slideable member 305 is operable based on the actuation of the rotor 307. For example, when the rotor 307 is actuated the biased slideable portion 305-3 can be decompressed and the slideable member 305 can move from a first position to second position. In response to the slideable member 305 moving from a first position to second position, the rotor 307 can be actuated. When the slideable member 305 moves from a first position to a second position, an adjustable post, coupled to the apparatus 330 can be unlocked.

The slideable member 305 can be actuated by the first rotor portion 307-1, the second rotor portion 307-2, the biased slideable portion 305-3, or combinations thereof. The slideable member 305 can be actuatable by the first rotor portion 307-1, the second rotor portion 307-2, the biased slideable portion 305-3, or combinations thereof to cause a cover (e.g., the cover 101 illustrated in FIG. 1) to be disengaged from a computing device.

The apparatus 330 can include a rotor 307. The rotor 307 can be in contact with a slideable member 305. The rotor 307 can include a first rotor portion (as shown in FIG. 3). In some examples, the first portion can be actuated in response to receiving a portion of a shaft via the aperture 309. In some examples, actuation of the rotor 307 can actuate the apparatus 330. Actuation of the apparatus 330 can cause the cover to be disengaged from the computing device.

The apparatus 330 can include an aperture 309. The aperture 309 can be proximal to the rotor 307. In some examples, the aperture 309 can receive a portion of the shaft to actuate the rotor 307. In some examples, the aperture 309 can actuate the rotor 307 by engaging a portion of the shaft with the rotor 307. In response to actuating the rotor 307, the apparatus 330 can actuate the slideable member 305 and disengage the adjustable posts coupled to the apparatus 330.

The apparatus 330 can include a rotor 307. The rotor 307 can be in contact with the slideable member 305. The rotor 307 can include a first rotor portion 307-1. In some examples, the first rotor portion 307-1 can be actuated in response to receiving a portion of a shaft via the aperture 309.

In some examples, the aperture 309 is to receive the portion of the shaft to actuate the rotor 307. In some examples, actuation of the rotor 307 actuates the apparatus 330 to cause the cover to move from a first position to a second position relative to the computing device. In some examples, actuation of the rotor 307 can actuate the apparatus 330.

FIG. 4 illustrates an example of an apparatus 440 consistent with the disclosure. The apparatus 440 can include a slideable member 405, a rotor 407, and an aperture 409 and a cover 401. Additionally, the apparatus 440 can include a first adjustable post 413-1 and a second adjustable post 413-2. The first adjustable post 413-1 and the second adjustable post 413-2 can be coupled to the rotor 407 of the apparatus 440. In some examples, when a slideable member 405 moves from a first position to a second position, the first adjustable post 413-1 and/or the second adjustable post 413-2 is unlocked. In some example, the first position can include the latch mechanism 403 being in a stationary position and the rotor 407 not being actuated. In some examples, the second position can include the rotor 407 being actuated and the slideable member 405 being compressed, thus being detached from the first adjustable post 413-1, and the second adjustable post 413-2.

The aperture 409 can receive a portion of a shaft (e.g., the shaft 211 illustrated in FIG. 2) to disengage the cover 401 from a computing device. The aperture 409 is proximal to the rotor 407. In some examples, the aperture 409, is to receive the portion of the shaft to actuate the rotor 407. In some examples, the aperture 409 can actuate the rotor 407 by engaging a portion of the shaft with the rotor 407. In response to actuating the rotor 407, the apparatus 440 can actuate the slideable member 405 and disengage the adjustable posts (e.g., first adjustable post 413-1 and/or the second adjustable post 413-2) coupled to the apparatus 440.

The apparatus 400 can include a first adjustable post 413-1 and a second adjustable post 413-2. When a shaft is not received by a latch mechanism 403, the first adjustable post 413-1 and/or the second adjustable post 413-2 are in a locked position.

The rotor 407 can include a first rotor portion 407-1 and a second rotor portion 407-2. The first rotor portion 407-1 can come in contact with a shaft and can be moved towards a first slideable portion 405-1 of the slideable member 405 (as illustrated in connection with FIG. 2A). In some examples, the second rotor portion 407-2 can move from a first position to a second position towards a second slideable portion 405-2 (illustrated in connection with FIG. 2B).

The slideable member 405 can include a first slideable portion 405-1, a second slideable portion 405-2, and a biased slideable portion 405-3. In some examples, the second slideable portion 405-2 can move from a first position to a second position in response to a shaft (e.g., the shaft 211 illustrated in connection with FIGS. 2A and 2B) being received by the rotor 407. In some example, the slideable member 405 is operable to cause the cover 401 to move from a first position to a second position in response to the rotor 407 being actuated.

In some examples, when the slideable member 405 moves from a first position to a second position, the first adjustable post 413-1 and the second adjustable post 413-2 can be unlocked. In some examples, first rotor portion 407-1 of the rotor 407 unlocks the first adjustable post 413-1 when the shaft pushes the first rotor portion 407-1 towards the cover 401. In some examples, second rotor portion 407-2 of the rotor 407 unlocks the second adjustable post 413-2 when the shaft pushes the second rotor portion 407-2 towards the cover 401.

The aperture 409 can receive a shaft. In response to the aperture 409 receiving the shaft, the biased slideable portion 405-3 can compress and cause the first adjustable post 413-1 to be unlocked. In some examples, the biased slideable portion 405-3 compresses to shift the second slideable portion 405-2 and cause the adjustable second post 413-2 to be unlocked. The first adjustable post 413-1 and the second adjustable post 413-2 are actuatable to lock and unlock the cover.

The figures herein follow a numbering convention in which the first digit corresponds to the drawing figure number and the remaining digits identify an element or component in the drawing. For example, reference numeral 105 can refer to element “05” in FIG. 1 and an analogous element can be identified by reference numeral 205 in FIG. 2. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to,” “coupled to,” or “coupled with” another element, it can be directly on, connected, or coupled with the other element or intervening elements can be present. In contrast, when an object is “directly coupled to” or “directly coupled with” another element it is understood that are no intervening elements (adhesives, screws, other elements), etc.

The above specification, examples and data provide a description of the method and applications, and use of the system and method of the disclosure. Since many examples can be made without departing from the spirit and scope of the system and method of the disclosure, this specification merely sets forth some of the many possible example configurations and implementations.

What is claimed:

1. An apparatus, comprising:
a cover coupleable to a computing device; and
a latch mechanism, wherein the latch mechanism is actuatable via insertion of a portion of a shaft through an aperture of the latch mechanism to cause the cover to be disengaged from the computing device.

2. The apparatus of claim 1, wherein the portion of the shaft comprises a portion of a key or a portion of a pin.

3. The apparatus of claim 1, wherein the latch mechanism comprises:
a slideable member;
a rotor in contact with the slideable member; and
the aperture, wherein the aperture is to receive the portion of the shaft to actuate the rotor, and wherein actuation of the rotor actuates the latch mechanism to cause the cover to move from a first position to a second position relative to the computing device.

4. The apparatus of claim 3, wherein a portion of the slideable member extends a first distance along a first surface of the latch mechanism.

5. The apparatus of claim 4, wherein a biased slideable portion of the slideable member is operable to adjust the slideable member based on the actuation of the rotor.

6. The apparatus of claim 5, wherein the actuation of the rotor causes an adjustable post to unlock.

7. An apparatus, comprising:
a rotor, comprising:
a first rotor portion;
a second rotor portion, wherein the rotor portion is actuated in response to a shaft being received by an aperture associated with the apparatus;
a biased slideable portion coupled to the rotor; and
a slideable member that is actuatable by the first rotor portion, the second rotor portion, the biased slideable portion, or combinations thereof to cause a cover to be disengaged from a computing device.

8. The apparatus of claim 7, wherein the slideable member comprises:
a first slideable portion to house the second rotor portion; and
a second slideable portion, wherein the second slideable portion moves from a first position to a second position in response to the shaft being received by the second rotor portion through the aperture.

9. The apparatus of claim 8, comprising an adjustable post coupled to the rotor, wherein when the second slideable portion moves from the first position to the second position, the adjustable post is unlocked.

10. The apparatus of claim 7, wherein the second rotor portion is to move towards the first rotor portion when the rotor is actuated.

11. An apparatus, comprising:
a cover;
an aperture to receive a shaft;
a first adjustable post;
a second adjustable post; and
a latch mechanism comprising:
a rotor; and
a slideable member, wherein the slideable member is operable to cause the cover to move from a first position to a second position in response to the rotor being actuated.

12. The apparatus of claim 11, wherein a first rotor portion of the rotor unlocks the first adjustable post when the shaft pushes the first rotor portion towards the cover.

13. The apparatus of claim 11, wherein in response to the aperture receiving the shaft, a biased slideable portion compresses and causes the first adjustable post to be unlocked.

14. The apparatus of 11, wherein the biased slideable portion compresses to shift a second slideable portion and cause the second adjustable post to be unlocked.

15. The cover of claim 11, wherein the first adjustable post and the second adjustable post are actuatable to lock and unlock the cover.
